(19) United States
(12) Patent Application Publication
(10) Pub. No.: US 2012/0081746 A1
(43) Pub. Date: Apr. 5, 2012

(54) PRINTING SYSTEM, METHOD FOR CONTROLLING THE SAME, AND STORAGE MEDIUM

(75) Inventor: Naohiro Yamaguchi, Kawasaki-shi (JP)

(73) Assignee: CANON KABUSHIKI KAISHA, Tokyo (JP)

(21) Appl. No.: 13/249,649

(22) Filed: Sep. 30, 2011

(30) Foreign Application Priority Data
Oct. 5, 2010 (JP) 2010-225991

(51) Int. Cl. G06F 3/12

(52) U.S. Cl. 358/1.15

(57) ABSTRACT

A printing system includes a print application and a printing apparatus. The print application sets metadata for an arbitrary content among a plurality of contents included in a print job, generates a job ticket in which the set metadata is associated with a print setting, and receives transmission conditions of a printing status in association with the metadata. The printing apparatus executes printing according to the print setting of the generated job ticket, and when the printing of the print setting referring to the metadata associated with the transmission conditions is executed in the job ticket, transmits the printing status to a transmission destination designated by the transmission conditions.

### BACKGROUND OF THE INVENTION

1. Field of the Invention

The present invention relates to a printing system, a method for controlling the same, and a storage medium.

2. Description of the Related Art

In recent years, a focus has been on a variable printing system that changes, with use of a digital printing machine, a part of contents of a print product to a designated content to print it. The use of the digital printing machine enables low-cost and fast variable printing by putting, to good use, characteristics of forming and printing an image on each page during each printing without any plate making necessary in a conventional offset printing machine. For example, for template data fixed in a plurality of records included in a print job, variable data varied in content from one record to another is printed, and hence variable printing different in content from one record to another is performed.

As one method, a printing system based on a Portable Document Format (PDF)/Variable and Transactional (VT) standard has been studied and constructed. According to the PDF/VT standard, a PDF file used as a printing content file is combined with print designation based on a Job Definition Format (JDF) job ticket to perform printing. A conventionally existent issue is a possibility that print content generation and print appearance determination of a print job are not always simultaneous in printing, and a change in one side may cause a change in the other. In such a case, a job change takes time, causing a schedule delay.

According to this method, metadata is set in an object in the PDF, and referred to in print appearance information of the JDF. Not reference to contents based on the number of pages in the PDF, which has conventionally been practiced, but indirect reference based on the metadata enables dynamic imposition that can more flexibly deal with content changes. Using the method simplifies job changing with respect to a change in print content during print job generation, thus achieving more flexible variable printing.

In the printing system based on the JDF job ticket, control of a print job and status transmission of a printing apparatus in a print work flow are executed by two-way communication that uses a Job Message Format (JMF) message. The printing apparatus that has received the print job performs printing, and transmits a printing result to a transmission application of the print job through the JMF message (JMF, hereinafter).

After detection of a printing trouble such as paper jamming or ink running-out, the printing apparatus transmits not only the printing result but also a JMF message indicating the occurrence of the trouble to a pre-designated transmission destination. For example, Japanese Patent Application Laid-Open No. 2004-362309 discusses a technique for transmitting, when an event designated by a user occurs in a printing apparatus, data to a pre-designated transmission destination from a print controller at a condition or timing designated in the transmission setting by the user.

In a variable printing system that processes a print job including a print setting based on a JDF job ticket and PDF data of the PDF/VT format, a content PDF of one print job may include a plurality of pieces of record information. In the variable printing system, not only conventional status transmission by a print job unit but also processing status transmission by a record information unit may be required.

However, as described above, one print job including the content of the PDF/VT format may include a plurality of pieces of record information. A size of each record changes depending on a content. In consequence, the conventional printing system cannot transmit a printing status of the print job according to an arbitrary condition desired by the user.

### SUMMARY OF THE INVENTION

The present invention is directed to a printing system that can transmit a processing status of a print job according to an arbitrary condition desired by a user.

According to an aspect of the present invention, a printing system includes a setting unit configured to set metadata for an arbitrary content among a plurality of contents included in a print job, a generation unit configured to generate a job ticket in which the metadata set by the setting unit is associated with a print setting set for the print job, a reception unit configured to receive a transmission condition of a printing status in association with the set metadata, a printing unit configured to execute printing according to the print setting of the job ticket generated by the generation unit, and a transmission unit configured to transmit, when the printing unit executes printing of the print setting referring to the metadata associated with the transmission condition in the job ticket, the printing status to a transmission destination designated by the transmission condition.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a variable printing system according to a first exemplary embodiment of the present invention.

FIG. 2 is a block diagram illustrating a configuration of a print application in the print system.

FIG. 3 is a block diagram illustrating a configuration of a printing apparatus in the printing system.

FIG. 4 is a conceptual diagram illustrating printing in a conventional variable printing system.

FIG. 5 is a conceptual diagram illustrating a variable print record information database.

FIG. 6 illustrates examples of a printing result of the variable printing system.

FIG. 7 is a schematic view illustrating a configuration of a print job.

FIG. 8 illustrates processing between a print application and the printing apparatus in the variable printing system according to the present invention.

FIG. 9 is a schematic view illustrating a JMF message for setting subscription in the variable printing system according to the present invention.

FIG. 10 is a sequential view illustrating JMF communication between the print application and the printing apparatus in the variable printing system according to the present invention.

FIG. 11 is a flowchart illustrating print job creation and transmission of the print application in the printing system according to the present invention.

FIG. 12 is a flowchart illustrating processing when printing information of the print application is received in the printing system according to the present invention.

FIG. 13 is a flowchart illustrating printing performed by the printing apparatus in the printing system according to the present invention.

FIG. 14 illustrates a user interface (UI) for setting transmission conditions of a printing status in the print application.

FIG. 15 is a flowchart illustrating printing performed by the printing apparatus in the printing system according to the present invention.

### DESCRIPTION OF THE EMBODIMENTS

Various exemplary embodiments, features, and aspects of the invention will be described in detail below with reference to the drawings.

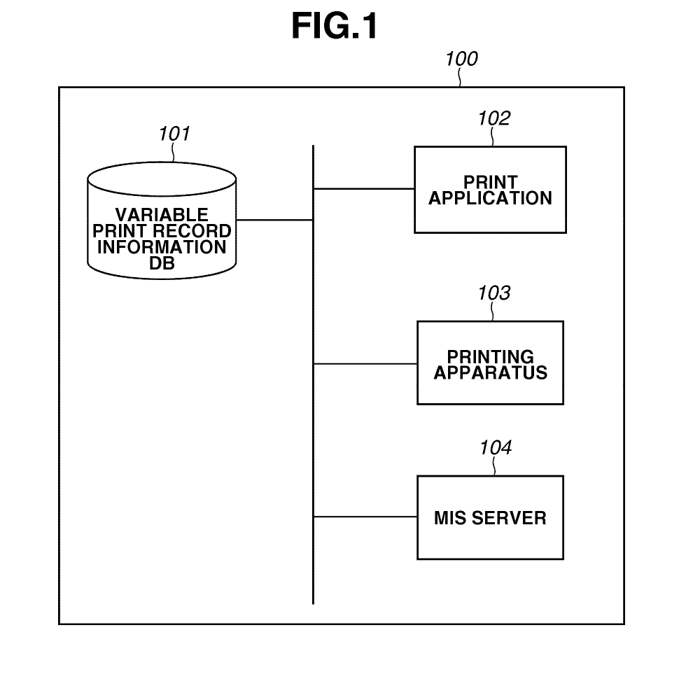

FIG. 1 is a block diagram illustrating a configuration of a variable printing system 100 according to a first exemplary embodiment. Components illustrated in the block diagram in FIG. 1 are interconnected via a network.

A variable print record information database (record database, hereinafter) 101 stores record information used for variable printing. A print application 102 generates a print job based on an operator's UI operation to transmit it to a printing apparatus 103. The print application 102 indicates an information processing apparatus such as a personal computer (PC) where an application has been installed. The printing apparatus 103 receives the print job generated by the print application 102 to perform printing.

A management information system (MIS) server 104 receives a job from a user or manages the print job generated by the print application 102. The operator operates on the print application 102 based on a content of the job received from the user by the MIS server 104 to generate a print job. The print application 102 or the printing apparatus 103 transmits a status of the print job in a work flow to the MIS server 104. The MIS server 104 calculates costs or manages resources based on the content of the received print job or progress information of the transmitted print job.

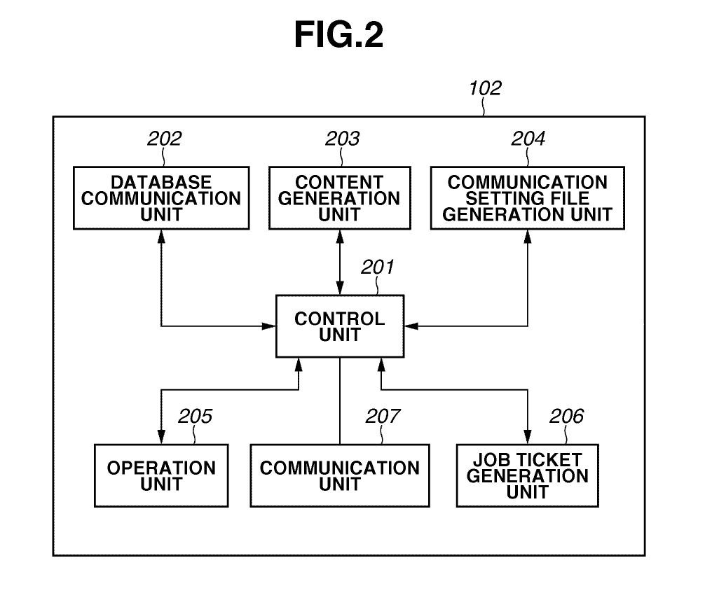

FIG. 2 is a block diagram illustrating a configuration of the print application 102. A control unit 201 controls the entire print application 102. A central processing unit (CPU) included in the control unit 201 executes a control program stored in a storage area to control the entire print application 102.

A database communication unit 202 communicates with the record database 101 to acquire record information that becomes a print content. The record database 101 stores the record information such as variable data pieces which are different from one record to another. A content generation unit 203 generates, based on the record information acquired by the database communication unit 202, print content data (print data) used for printing at the printing apparatus 103. Representative print data are PDF data, Post Script (PS) data, Tagged Image File Format (TIFF) data, and a Joint Photographic Experts Group (JPEG) image. Various Page Description Language (PDL) data are also used. Hereinafter, the printing system is described by taking the PDF data as an example of print data.

A communication setting file generation unit 204 generates a communication setting file (JMF) for controlling the print job or the printing apparatus 103. An operation unit 205 which is an operation UI for the print application 102 can display a print setting screen for the print job or a printing progress status.

A job ticket generation unit 206 generates, based on the print data generated by the content generation unit 203 and the print setting set by the operation of the operation unit 205, a print job for printing at the printing apparatus 103. A communication unit 207 transmits the print job to the printing apparatus 103. During execution of the print job, the printing apparatus 103 transmits a printing progress status of the print job to the print application 102. The printing progress status transmitted from the printing apparatus 103 is received by the communication unit 207, and the received progress status is displayed by the operation unit 205.

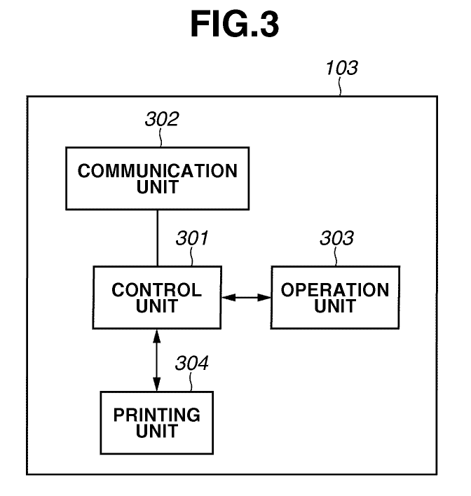

FIG. 3 is a block diagram illustrating a configuration of the printing apparatus 103. A control unit 301 controls the entire printing apparatus 103. A CPU included in the control unit 301 executes a control program stored in a storage area to control the entire print application 102.

A communication unit 302 receives the print job transmitted from the print application 102. The communication unit 302 transmits the printing progress status to the print application 102 or the MIS server 104. An operation unit 303 is a UI unit for changing printing or print setting on the printing apparatus 103, changing setting of the printing apparatus, or preventing errors. A printing unit 304 prints a print content included in the print job received by the communication unit 302 according to the print setting.

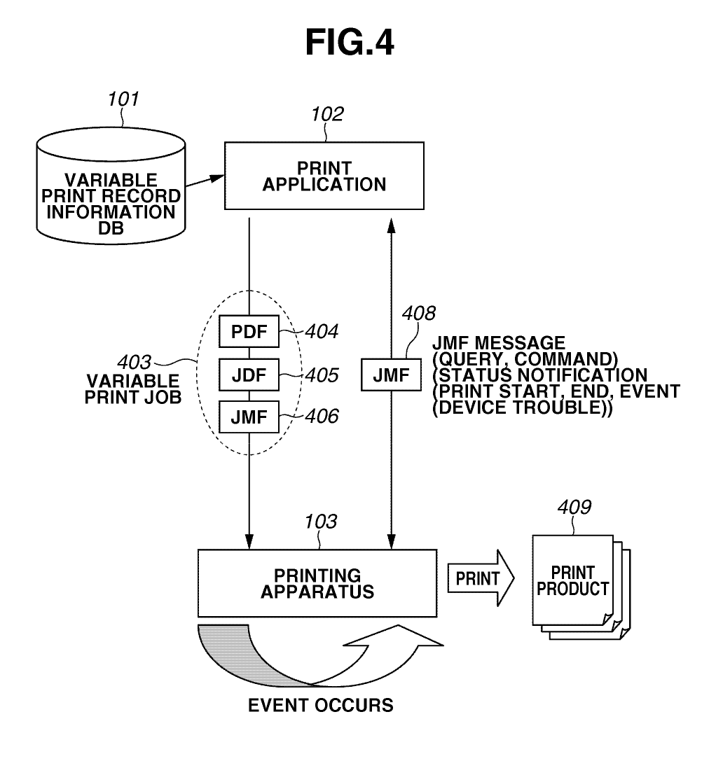

FIG. 4 illustrates an outline of variable printing using a JDF job ticket in the variable printing system 100.

The print application 102 acquires record information designated by the user from pieces of record information stored in the record database 101, and generates a variable print job 403 based on the record information. The variable print job 403 includes a content PDF file 404, a JDF job ticket 405, and a JMF 406.

The content PDF file 404 is print data generated by the content generation unit 203 which contains image data used for printing. On each page included in the PDF file, an image corresponding to the record information acquired from the record database 101 is set. The PDF file 404 includes a plurality of objects such as an image object, a graphics object, and a text object. Arbitrary metadata is set for these arbitrary objects, a page object combining these objects to constitute a page, or a document object further combining these objects to constitute a document.

The JDF job ticket 405 is a job ticket generated by the job ticket generation unit 206, which is an Extensible Markup Language (XML) file containing a print setting of the variable print job 403. For the print setting, the number of copies, a sheet, two-sided or one-sided printing, print appearance such as 2-in-1 print setting in which content images of two pages of the content PDF file 404 are arrayed on a one-page sheet surface to be laid out, or post processing such as stapling, punching or binding is designated.

The JDF job ticket 405 refers to the content PDF file 404 inside as image data that becomes a print content. More specifically, in an XML tag portion corresponding to the print appearance of the JDF ticket 405, arbitrary data set in each object of the content PDF file 404 is referred to. This enables print setting by an arbitrary object unit in the print setting of the JDF job ticket 405.

The JMF 406 is described in XML, and the JDF job ticket 405 is referred to. The JMF 406 is a communication setting file generated by the communication setting file generation unit 204 to instruct processing in the printing apparatus 103 of the variable print job 403. As an example, through the JMF 406, the print application 102 instructs the printing apparatus 103 to hold the print job by a hold queue without printing the print job immediately after its reception. Accordingly, the operator can adjust a schedule in a state where the printing apparatus 103 holds the job, or change the print setting of the job. After preparation has been made, the operator releases the print job from the hold queue to execute printing.

The JDF job ticket 405 is referred to inside the JMF 406. Hence, the JDF job ticket 405 does not need to be physically contained in the variable print job 403 to be simultaneously transmitted as long as it can be referred to by the printing apparatus 103 that processes it. Similarly, the content PDF file 404 is referred to from the JDF job ticket 405. Thus, the content PDF file 404 does not need to be contained in the variable print job 403 to be simultaneously transmitted as long as it can be referred to by the printing apparatus 103. When receiving the variable print job 403 from the print application 102, the printing apparatus 103 processes the print job according to an instruction of the JMF 406. As a result of the printing, the printing apparatus 103 outputs a print product 409.

A JMF 408 is information mutually communicated between the print application 102 and the printing apparatus 103. The printing apparatus 103 describes a printing progress status indicating a result or a status of processing in the JMF 408 and transmits it to the print application 102. To understand the processing state of the printing apparatus 103, the print application 102 describes a query message in the JMF 408 and transmits it to the printing apparatus 103. The printing apparatus 103 that has received the JMF 408 describes information designated by the query message, such as a processing status of the print job, a state of the printing apparatus itself, or a resource status, in the JMF 408 to transmit it to the print application 102.

When an event of some kind occurs in the printing apparatus 103 during processing, the printing apparatus 103 transmits the JMF 408 indicating a status to the print application 102. The print application 102 that has received the JMF 408 displays a content of the received message on the UI to transmit it to the user. Further, the print application 102 executes corresponding processing based on the received JMF 408. Representative events transmitted from the printing apparatus 103 may be a printing start or end of the print job, a shortage of consumables such as ink or paper necessary for printing, and a failure or error in the printing apparatus 103.

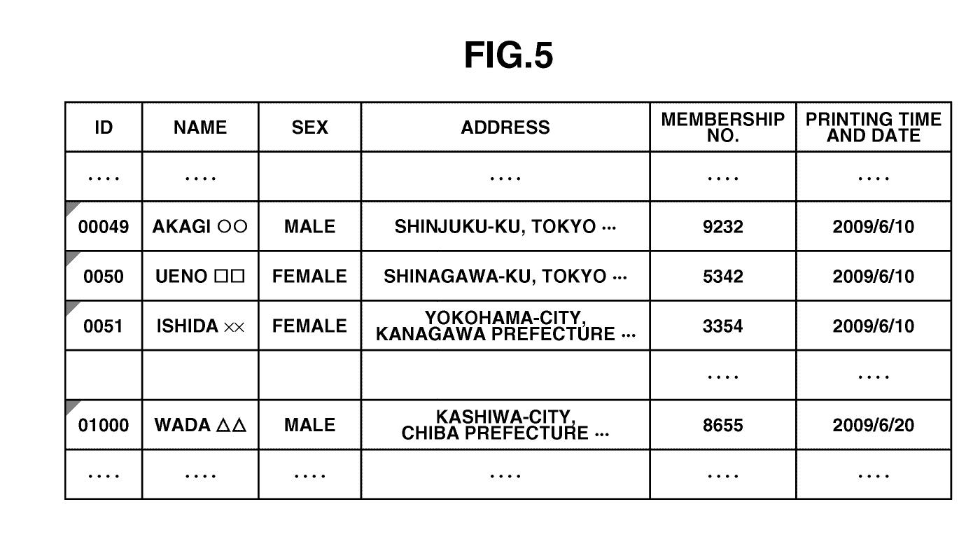

FIG. 5 illustrates an example of the record information stored in the record database 101. Each record is identified by identification (ID). Attributes of each record include information such as a name, a sex, an address, a membership number, and time and date to start printing. These attributes are configured according to contents of the print product.

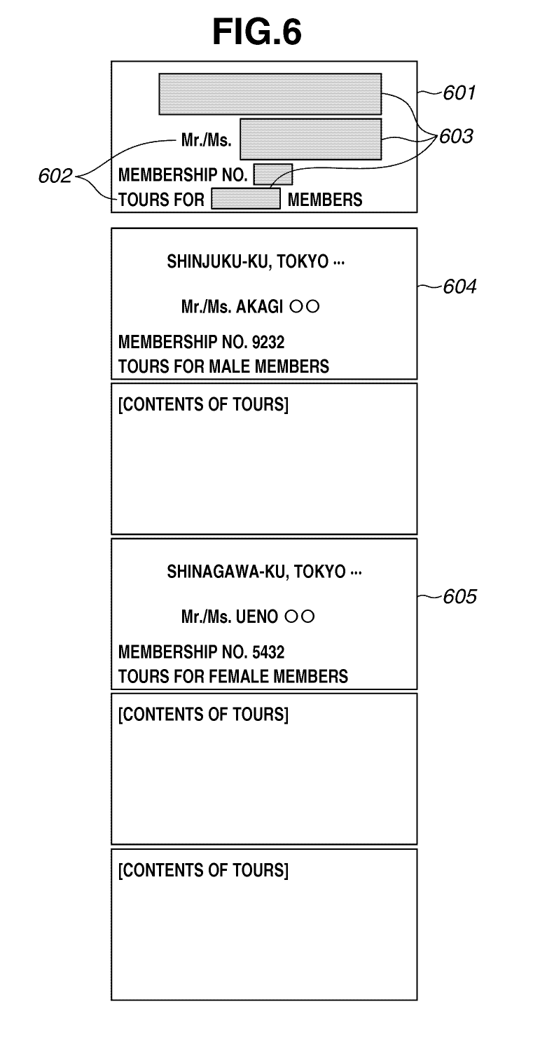

FIG. 6 illustrates an example of a result of printing performed in the variable printing system 100. In the variable printing system 100, the print application 102 defines template data 601. The template data 601 includes a fixed area 602 not changed for each record and a variable area 603 for acquiring data from the outside to print a content varied from one record to another. The print application 102 synthesizes an image in the variable area 603 of the template data based on the record information acquired from the record database 101.

FIG. 6 illustrates examples of printing results 604 and 605 of two records identified by record IDs 00049 and 00050, using the template data 601 to which, among the pieces of record information illustrated in FIG. 5, the address, the name, the membership number, and the sex are input. The printing result 604 is a result when the record information about the record ID 0049 is synthesized with the template data 601. The printing result 605 is a result when the record information about the record ID 0050 is synthesized with the template data 601.

An image of the printing result depends on the record information referred to by the print application, and hence the number of pages of content images constituting one record varies from one record to another. For example, in the printing results illustrated in FIG. 6, the number of pages of contents of tours included in the record varies between male and female. Thus, in the case of the sex of male among the attributes of the record information, as illustrated by the printing result 604, the number of pages included in the record is two. On the other hand, in the case of the sex of female among the attributes of the record information, as illustrated by the printing result 605, the number of pages included in the record is three.

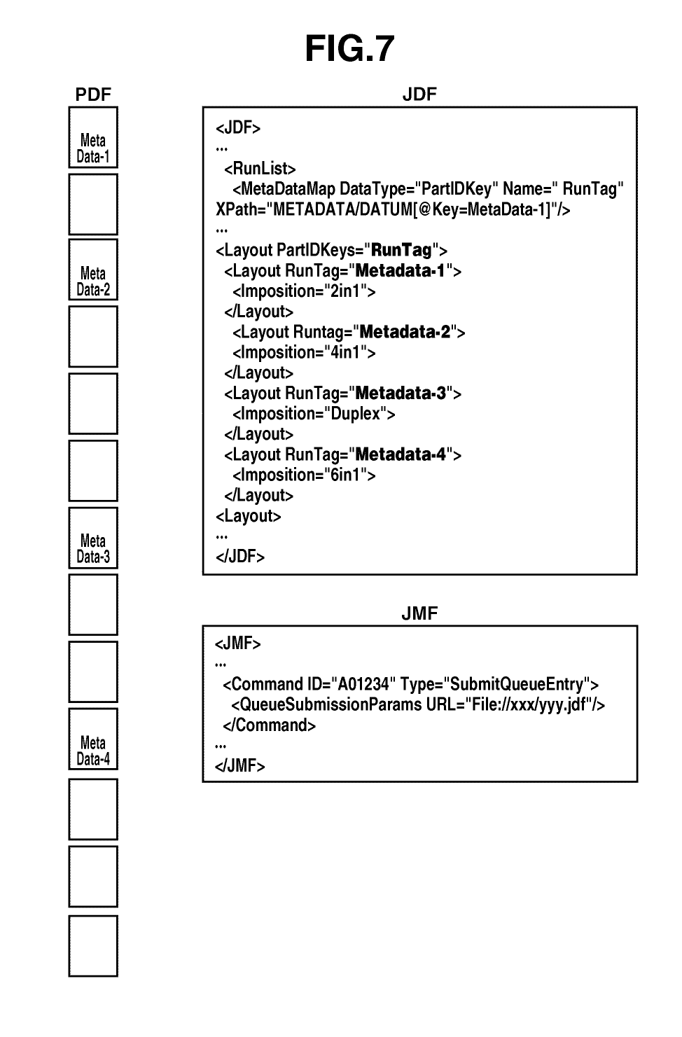

FIG. 7 is a schematic view illustrating a configuration of a print job generated by the print application 102.

The variable print job includes a PDF that is a print content file, a JDF that is a job ticket indicating a print setting, and a JMF for a communication setting. The PDF is an image page group created from record information varied in content from one case to another, and the number of pages varies from one record to another. It is assumed, as an example, that a metadata tag (“MetaData-x”) is set at a first page of a page group corresponding to each record information.

The print setting is described in the JDF. For example, to change printing imposition appearance for each page group corresponding to each record, the metadata tag set at the first page of the page group corresponding to each record in the PDF file is referred to by a Layout tag.

In the JMF, it is specified to enter the print job into a print queue of the printing apparatus 103. The printing apparatus 103 that has received the JMF analyzes the JDF file, and prints the PDF based on the content.

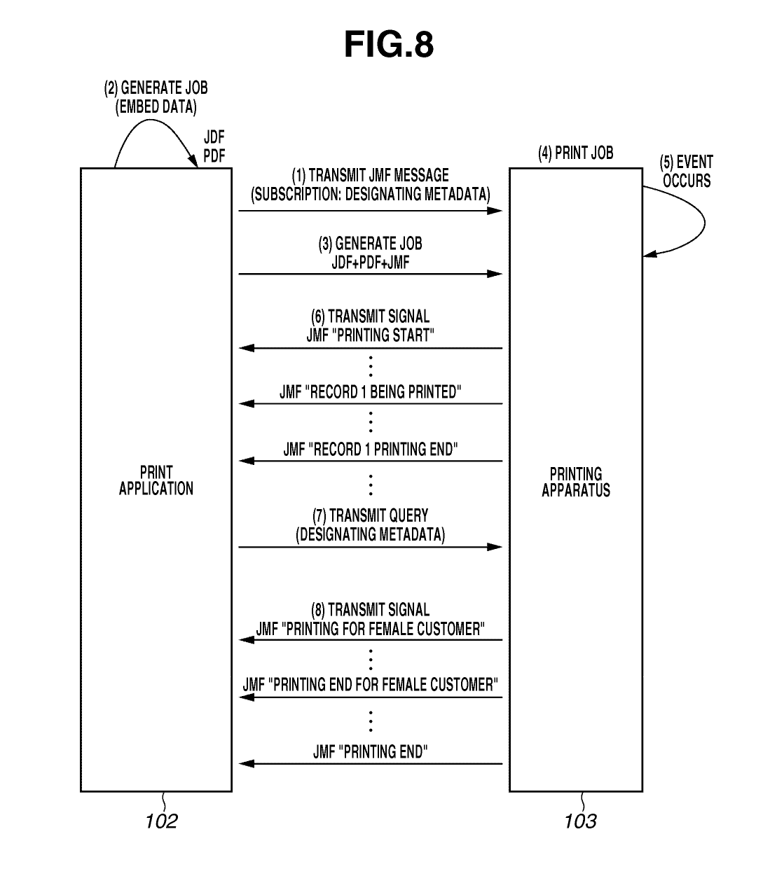

FIG. 8 illustrates an example of processing between the print application 102 and the printing apparatus 103 in the variable printing system 100.

The communication unit 207 of the print application 102 establishes communication with the printing apparatus 103, and transmits information regarding metadata set by the operator using the JMF to the printing apparatus 103.

The metadata is set for a PDF object included in the PDF so as to correspond to timing for acquiring a processing status for each record or each page during processing. For example, to check a printing status or result for each record in the variable print job including a plurality of records, metadata is set for the PDF object corresponding to each record in advance during PDF creation.

The job ticket generation unit 206 generates a JDF in which a print setting applied to each PDF object in the PDF is described. For the print setting described in the generated JDF, metadata of each object in the PDF is referred to.

Then, the print application 102 generates a print job. The print job includes a content PDF file (PDF, hereinafter), a JDF job ticket (JDF, hereinafter), and a JMF. The PDF, the JDF, and the JMF are respectively generated by the content generation unit 203, the job ticket generation unit 206, and the communication setting file generation unit 204. Metadata transmitted to the printing apparatus 103 is set for a PDF object included in the print job.

The printing apparatus 103 that has received the print job executes printing. In this case, when the PDF including the object containing the metadata designated by the JMF is processed (event occurs), the printing apparatus 103 transmits a JMF to the print application 102 each time. The print application 102 that has received the JMF can accordingly understand a processing status of the printing apparatus 103 at processing timing of a plurality of metadata tags included in one print job, and display the processing status on the UI, so that a progress can be displayed to the user.

Before the printing apparatus 103 completes printing of the print job, the print application 102 can transmit a JMF for setting conditions again in the printing apparatus 103 and change JMF transmission conditions during the printing. For example, it is presumed that transmission of a printing status by a record unit is planned before print job transmission. When the operator wants to check a processing status of the print job for a female customer by determining a printing result during printing, a JMF indicating this condition is transmitted to the printing apparatus 103 during the printing. Then, the printing apparatus 103 that has received the JMF changes JMF transmission conditions, and JMF is transmitted to the print application 102 according to the conditions thereafter.

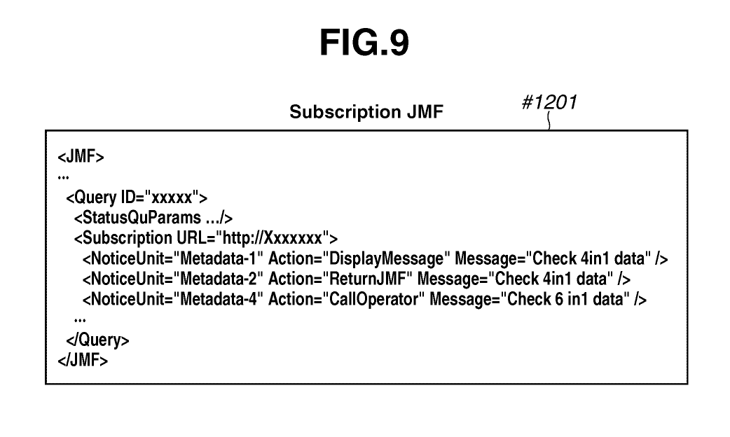

FIG. 9 illustrates an example of a JMF for setting subscription generated by the print application 102 in the variable print system 100. The printing apparatus 103 that has received a JMF 1201 continuously transmits a processing status of the printing apparatus 103 to a designated URL thereafter until processing of a print job designated by the JMF is completed or a JMF for releasing the setting is received from the print application 102.

The print application 102 sets a condition for status transmission before print job transmission, and transmits the condition as the JMF 1201 to the printing apparatus 103. The condition to be set is a metadata tag set in a JDF job ticket. The metadata tag is designated at a first page of a PDF page group of each record contained in a PDF that becomes a variable print content as illustrated in FIG. 7. The printing apparatus 103 processes print appearance having the metadata tag set, the metadata tag has been designated beforehand by the JMF 1201, during processing of the print job including the JDF, and then generates an event.

In the JMF 1201, an event is designated which is generated by the printing apparatus 103 during processing of the designated metadata tag. Events that can be designated depend on a capability of the printing apparatus 103. Examples are message displaying on the operation unit 303, JMF transmission to a designated URL, and an operator call to announce a status to the operator by a buzzer or a lamp.

In the JMF 1201, it is designated a message to be displayed on the operation unit 303 of the printing apparatus 103 when an event occurs. As described above, by designating an event generation condition and processing when an event occurs for the printing apparatus 103 before the print job transmission, the print application can receive an arbitrary status transmission at arbitrary timing during the processing of the print job.

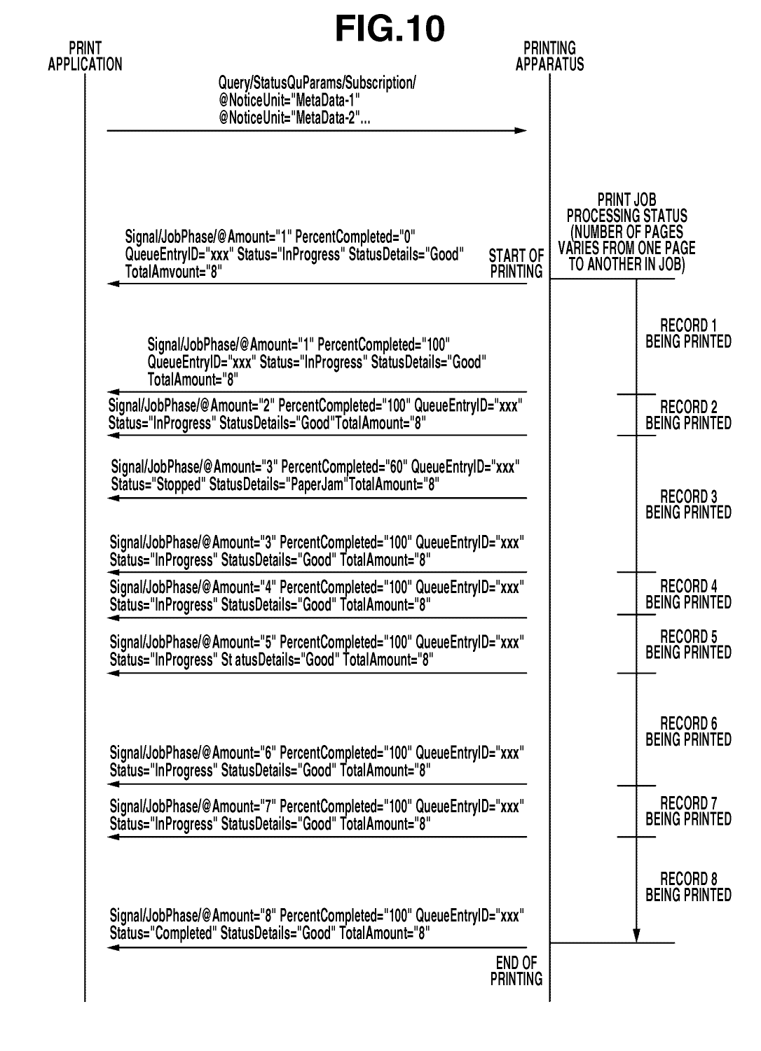

FIG. 10 is a sequential view illustrating an example of JMF communication between the print application 102 and the printing apparatus 103. The print application 102 transmits a subscription JMF designating the metadata tag illustrated in FIG. 6 to the printing apparatus 103 before a start of printing.

In a PDF, a metadata tag is set by a record unit. By designating the metadata tag in the JMF, a predetermined event occurs when the printing apparatus 103 processes the metadata tag reference part of the JDF.

The printing apparatus 103 transmits the JMF to the print application 102 in response to the event generation. In this case, rather than transmission of JMFs at a predetermined interval such as every N seconds, status transmission is executed in response to generation of an event designated by the metadata tag during the printing of the printing apparatus 103. Thus, timing for transmitting the JMF from the printing apparatus 103 to the print application 102 varies from one print job to another. Therefore, the operator can receive information about the printing apparatus 103 at timing suited to a job with use of the metadata tag.

In the example illustrated in FIG. 10, the printing apparatus 103 transmits its status using the JMF to the print application 102 each time printing of one record is completed during the printing of the print job including eight records different from one another in number of included pages.

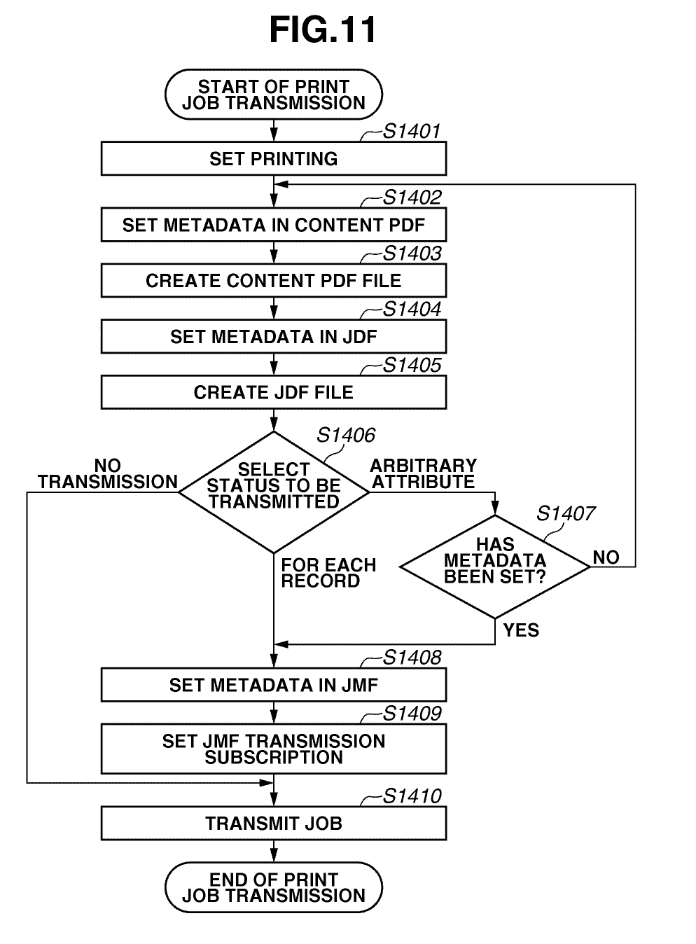

FIG. 11 is a flowchart illustrating a processing flow of print job creation and transmission performed by the print application 102.

In step S1401, the control unit 201 receives print settings from the operator via the operation unit 205. Instep S1402, the control unit 201 controls the content generation unit 203 according to the received print setting to set metadata in a PDF. In this case, the content generation unit 203 acquires record information from the record database 101, and sets the metadata to the acquired record information by corresponding thereto. A printing status at the printing apparatus 103 can accordingly be acquired by a record unit.

In step S1403, the control unit 201 causes the content generation unit 203 to generate a PDF that is print data to be printed by the printing apparatus 103 according to the set metadata. In step S1404, the control unit 201 controls the job ticket generation unit 206 to associate the metadata set in step S1402 with a printing imposition setting of a JDF (job ticket) and set the metadata in the JDF.

In step S1405, the control unit 201 controls the job ticket generation unit 206 to edit the JDF based on the metadata set in step S1405 and create a JDF reflecting the metadata.

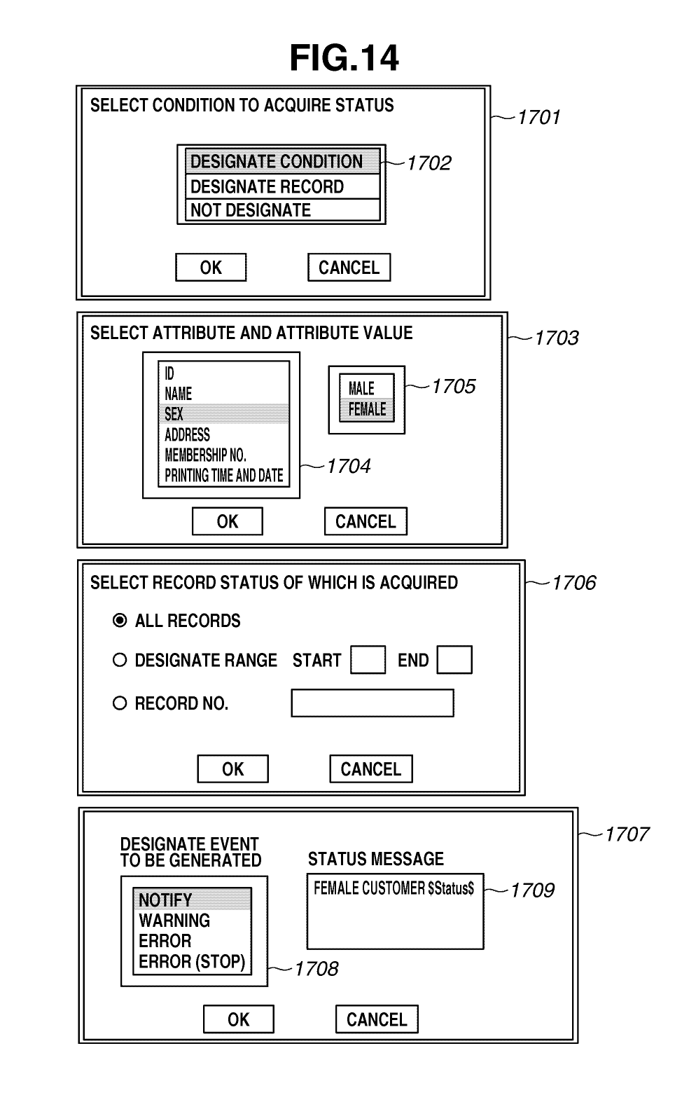

In step S1406, the control unit 201 receives, from the user, transmission conditions for transmitting a printing status during printing of a print job being generated at the printing apparatus 103 via the operation unit 205. There are three kinds of transmission conditions selected by the user, namely, “transmission for each record”, “transmission at arbitrary attribute”, and “no transmission”. The reception of the transmission conditions is described in detail below referring to FIG. 14.

When the transmission condition received from the user is “transmission for reach record” in step S1406, the processing proceeds to step S1408. In the case of “transmission at arbitrary attribute”, the processing proceeds to step S1407. In the case of “no transmission”, the processing proceeds to step S1410.

In step S1407, the control unit 201 determines, for attributes designated relating to transmission of the printing status, whether metadata has been set in a corresponding object of the PDF.

When it is determined that metadata has been set in the object (YES in step S1407), the processing proceeds to step S1408. The control unit 201 causes the communication setting file generation unit 204 to set metadata information corresponding to the object in a JMF.

When it is determined that no metadata has been set (NO in step S1407), the processing proceeds to step S1402. The control unit 201 causes the content generation unit 203 to set the metadata in the object of the PDF to be referred to.

When the transmission condition received from the user is “transmission for each record” in step S1406, the processing proceeds to step S1408. In step S1408, the control unit 201 causes the communication setting file generation unit 204 to set, as trigger information for setting printing conditions in the JMF, metadata information for referring to each record information. The communication setting file generation unit 204 generates a JMF from the set content.

In step S1409, the control unit 201 causes the communication unit 207 to transmit the JMF set in step S1408 to the printing apparatus 103 to set transmission conditions of a processing status of a print job to be transmitted (subscription setting) thereto.

In step S1410, the control unit 201 causes the communication setting file generation unit 204 to generate a JMF in which the print job has been set. Then, the control unit 201 causes the communication unit 207 to transmit the print job including the JDF, PDF, or JMF to the printing apparatus 103. In this case, the JDF or the PDF does not need to be transmitted simultaneously with the JMF as long as it has a format that can be referred to and acquired.

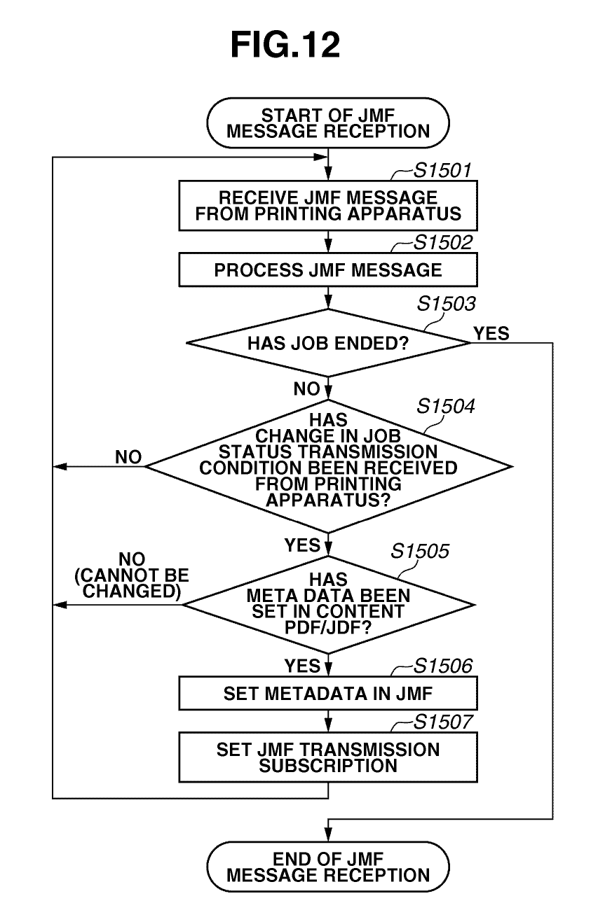

FIG. 12 is a flowchart illustrating processing when the print application 102 receives a JMF that contains information indicating a printing status of a print job at the printing apparatus 103.

In step S1501, the communication unit 207 receives the JMF indicating the processing status of the print job from the printing apparatus 103. In step S1502, the control unit 201 analyzes the JMF received by the communication unit 207, and executes processing corresponding to the JMF such as displaying on the operation unit 205 or error processing based on the described information.

In step S1503, the control unit 201 determines whether the print job has ended by referring to the processing status of the print job acquired from the JMF received from the printing apparatus 103. When it is determined that the print job has ended (YES in step S1503), the reception of the JMF is ended. When it is determined that the print job has not ended (NO in step S1503), the processing proceeds to step S1504.

In step S1504, the control unit 201 determines whether a change in transmission condition of the JMF indicating the printing status of the print job has been received from the user via the operation unit 205. When it is determined that the transmission condition change has been received (YES in step S1504), the processing proceeds to step S1505. When it is determined that no transmission condition change has been received (NO in step S1504), the processing returns to step S1501.

In step S1505, referring to the PDF and the JDF of the print job that is a printing target, the control unit 201 determines whether pieces of metadata corresponding to the changed transmission condition have been set in the PDF and the JDF that have been referred to. When it is determined that the corresponding metadata pieces have been set (YES in step S1505) , the processing proceeds to step S1506.

When it is determined that no corresponding metadata has been set (NO in step S1505), not metadata corresponding to the changed transmission condition can be detected at the printing apparatus 103 side. Hence, the printing apparatus 103 cannot transmit any JMF according to the transmission condition change. The processing accordingly proceeds to step S1501 without changing the transmission condition. In this case, it is desirable that a message indicating that the transmission condition could not changed to be displayed to the user via the operation unit 205.

In step S1506, the control unit 201 causes the communication setting file generation unit 204 to generate a JMF containing subsection having the changed transmission condition reset. In step S1507, the control unit 201 transmits the JMF set in step S1506 to the printing apparatus 103 to set the transmission condition for the processing status of the print job to be transmitted in the printing apparatus (subscription setting). After the processing in step S1507, the processing returns to step S1501.

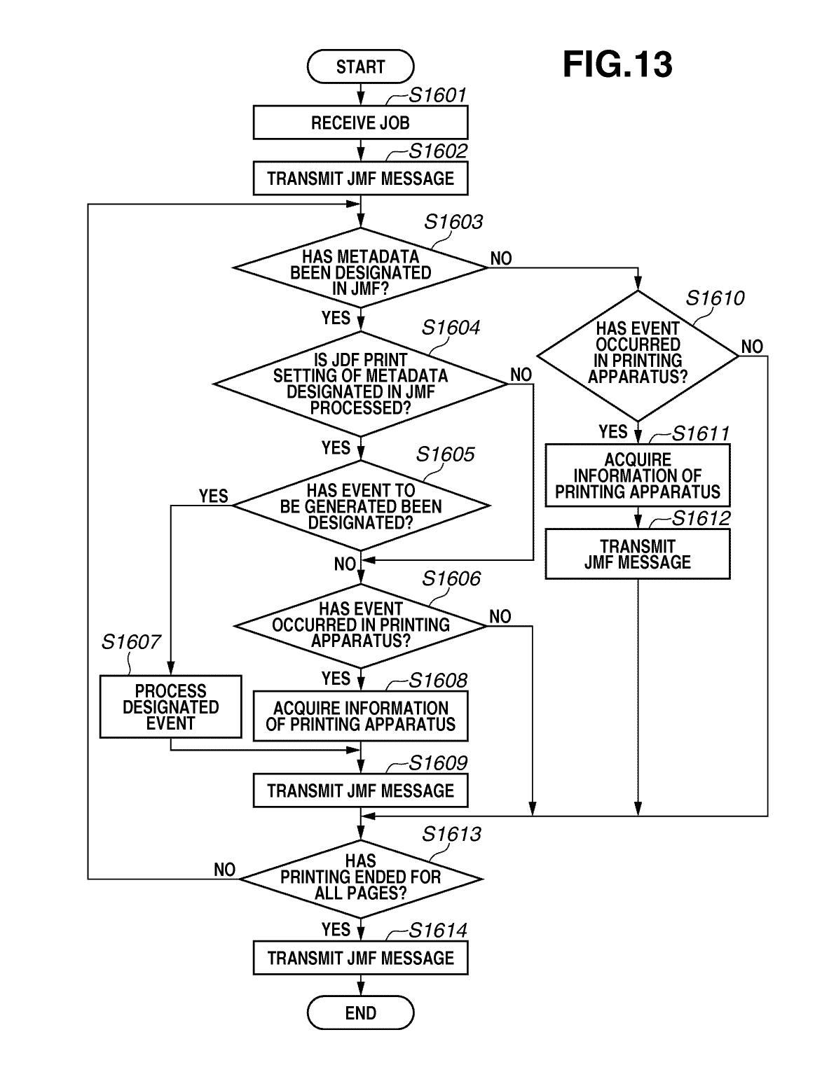

FIG. 13 is a flowchart illustrating printing performed by the printing apparatus 103 that has received a print job generated by the print application 102.

In step S1601, the communication unit 302 receives the print job from the print application 102. In step S1602, the control unit 301 of the printing apparatus 103 that has detected correct reception of the print job causes the communication unit 302 to transmit a JMF indicating the reception of the print job to the print application 102.

In step S1603, the control unit 301 determines whether metadata regarding transmission of a printing status has been set in the JMF received before the print job is processed.

It is presumed that before print job transmission, the print application 102 has transmitted a JMF containing subscription to the printing apparatus 103, and communication has been established to acquire a status between the print application and the printing apparatus. At that time, the control unit 301 determines whether at least one metadata tag has been designated in the JMF simultaneously with determination as to setting of subscription. When it is determined that metadata has been designated (YES in step S1603), the processing proceeds to step S1604. When it is determined that no metadata has been designated (NO in step S1603), the processing proceeds to step S1610.

In step S1604, the control unit 301 analyzes JDF and PDF data contained in the print job, and causes the printing unit 304 to print an object included in the PDF based on a result of the analysis. In this case, the control unit 301 determines whether to process print setting of the JDF that refers to the metadata designated in the JMF during printing in the printing unit 304. When it is determined to process the print setting (YES in step S1604), the processing proceeds to step S1605. When it is determined not to process the print setting (NO in step S1604), the processing proceeds to step S1606.

In step S1605, the control unit 301 determines whether an event generated in association with the metadata tag has been designated in the subscription message of the JMF received in advance before the print job transmission. When it is determined that no event generated in association with the metadata tag has been designated (NO in step S1605) , the control unit 301 advances the processing to step S1606, and transmits no JMF until an event such as a job start/end or an error occurs at the printing apparatus 103 as usual. When it is determined that an event generated in association with the metadata tag has been designated (YES in step S1605), the processing proceeds to step S1607.

In step S1607, the control unit 301 executes designated arbitrary event processing. Event processing examples are changing of a content of a JMF transmitted to the print application 102 or the MIS server 104 to a designated content or displaying of a designated message on the operation unit 303 according to the event generated in association with the metadata. Other event processing examples are designated operations including printing of a status page executed in the printing apparatus 103 separately from the printing of the print job, buzzer sounding, and lamp lighting.

In step S1606, the control unit 301 determines whether an event such as a start/end of the print job or an error during the printing has occurred in the printing apparatus 103. When it is determined that an event has occurred (YES in step S1606), the processing proceeds to step S1608. When it is determined that no event has occurred (NO in step S1606), the processing proceeds to step S1613. In step S1608, the control unit 301 acquires information about the printing apparatus 103 regarding the generated event.

In step S1609, the control unit 301 causes the communication unit 302 to transmit a JMF indicating a printing status of the print job to a URL that is a designated transmission destination. The JMF transmitted by the communication unit 302 contains the content changed according to the instruction in the event processing in step S1607 or the information acquired in step S1608.

When no metadata tag in the JMF is referred to, the control unit 301 performs the JMF transmission same as that when the event occurs during the printing. In step S1610, the control unit 301 determines whether an event such as a start/end of the print job or an error during the processing has occurred in the printing apparatus 103.

When it is determined that an event has occurred (YES in step S1610), in step S1611, the control unit 301 acquires information regarding the event generated in the printing apparatus 103. In step S1612, the control unit 301 causes the communication unit 302 to transmit the information as a JMF to the designated URL.

In step S1613, the control unit 301 determines whether printing has ended for all pages included in the print job. When it is determined that printing has ended for all the pages (YES in step S1613), the processing proceeds to step S1614. When it is determined that printing has not ended for all the pages, the processing proceeds to step S1603. In step S1614, the control unit 301 causes the communication unit 302 to transmit a JMF indicating an end of printing of the print job to the designated URL, and then ends the processing.

FIG. 14 illustrates an example of a UI for receiving transmission conditions of a printing status displayed on the operation unit 205.

The control unit 201 of the print application displays a screen 1701 on the operation unit 205, and receives an item and a condition for acquiring a status of each print job from the user. When “designate condition” is selected from a selection table 1702, the control unit 201 displays a screen 1703 for setting attributes of respective pieces of record information as conditions for transmission without using any number of record information contained in the variable print job.

When “designate record ” is selected from the selection table 1702 on the screen 1701, the control unit 201 displays a screen 1706 on the operation unit 205 to set a number of record information of the variable print job as conditions for transmission. When “not designate” is selected from the selection table 1702 on the screen 1701, the control unit 201 determines that no transmission condition is set.

On the screen 1703, the control unit 201 receives the attributes of the record information as the transmission conditions. The operation unit 205 enumerates the attributes contained in the record information of the variable print job on a table 1704. The operation unit 205 displays an attribute value of the attribute selected from the table 1704.

The control unit 201 receives record conditions as status transmission conditions on a screen 1706. On the screen 1706, each record, a record range, and an arbitrary record can be designated as conditions. The control unit 201 designates an event and its content which occurs when the printing apparatus prints a record matching the conditions designated on the screen 1703 or 1706.

The operation unit 205 designates an event on a table 1708. In a text box 1709, a text message to be displayed on the operation unit 205 when an event occurs or described in a JMF transmitted to a URL designated from the printing apparatus is designated. When pressing of an OK button on a screen 1707 is detected, the control unit 201 causes the communication setting file generation unit 204 to set the selected attribute and its attribute value in a JMF as status acquisition conditions from the printing apparatus.

A second exemplary embodiment is described below. The second embodiment is almost similar to the first exemplary embodiment illustrated in FIG. 13. Thus, only different portions are described while omitting common portions.

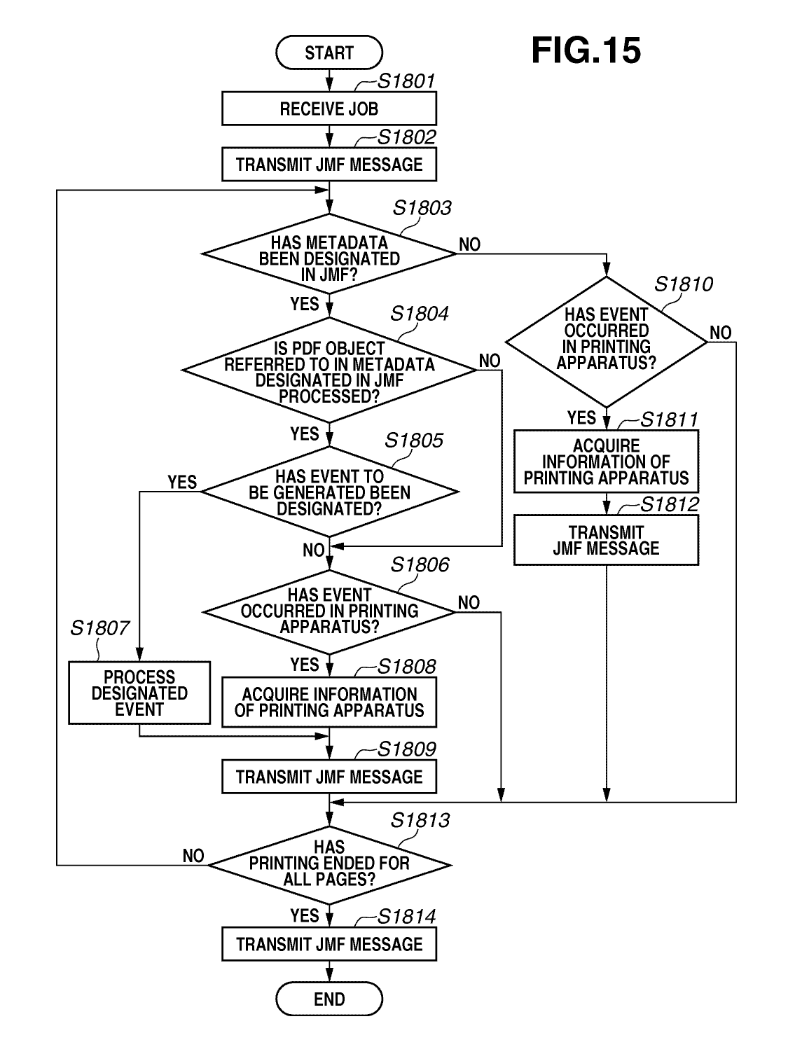

FIG. 15 is a flowchart illustrating printing performed by a printing apparatus 103 according to the present exemplary embodiment. When a subscription JMF containing metadata is received before reception of a print job, the processing proceeds to step S1804.

In step S1804, the printing apparatus 103 prints a PDF based on print appearance designated by a JDF. In this case, if metadata set in a PDF object as a print target matches metadata referred to in the JMF, a control unit 301 of the printing apparatus 103 advances the processing to step S1805.

In step S1805, the control unit 301 determines whether an event generated in association with a metadata tag has been designated in the subscription message of the JMF received in advance before reception of the print job. When it is determined that no metadata tag has been designated (NO in step S1805), the control unit 301 advances the processing to step S1806, and transmits no JMF until an event such as a start/end of a job, or an error occurs at the printing apparatus as usual.

Thus, when wishing to acquire a status again under different conditions after transmission of a job while there is no metadata set in the JDF, only by transmitting a JMF in which metadata has been changed to the printing apparatus, status transmission conditions of the printing apparatus can be changed.

The exemplary embodiments of the present invention have been described. However, the present invention is not limited to the configurations thereof. Any configuration can be employed as long as it can achieve functions in the claims and the functions of the exemplary embodiments.

In the conventional variable printing system, a processing status of a print job can be acquired only under fixed conditions such as a predetermined time interval. According to the printing system of the present invention, however, referring to metadata as an acquisition status of a processing status enables acquisition of a printing status of a print job in the printing apparatus under arbitrary conditions. The user can accordingly change status acquisition conditions freely without recognizing and changing a content or a structure of a once transmitted print job. Thus, convenience can be improved.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-225991 filed Oct. 5, 2010, which is hereby incorporated by reference herein in its entirety.

What is claimed is:

1. A printing system comprising:
a setting unit configured to set metadata for an arbitrary content among a plurality of contents included in a print job;
a generation unit configured to generate a job ticket in which the metadata set by the setting unit is associated with a print setting set for the print job;
a reception unit configured to receive a transmission condition of a printing status in association with the set metadata;
a printing unit configured to execute printing according to the print setting of the job ticket generated by the generation unit; and
a transmission unit configured to transmit, if the printing unit executes printing of the print setting referring to the metadata associated with the transmission condition in the job ticket, the printing status to a transmission destination designated by the transmission condition.

2. The printing system according to claim 1, wherein the reception unit receives, as the transmission conditions, an attribute of the metadata and an attribute value of the attribute, and when the printing unit executes printing of the print setting referring to the received attribute value in the job ticket, the transmission unit transmits the printing status.

3. The printing system according to claim 1, wherein the reception unit receives, as the transmission condition, a content of a message to be transmitted to the transmission destination, and when the printing unit executes printing of the print setting referring to the metadata associated with the transmission condition in the job ticket, the transmission unit transmits the printing status based on the content of the message designated by the transmission condition.

4. A method for controlling a printing system, the method comprising:
setting metadata for an arbitrary content among a plurality of contents included in a print job;
generating a job ticket in which the set metadata is associated with a print setting set for the print job;
receiving a transmission condition of a printing status in association with the set metadata;
executing printing according to the print setting of the generated job ticket; and
transmitting, when the printing of the print setting referring to the metadata associated with the transmission condition is executed in the job ticket, the printing status to a transmission destination designated by the transmission condition.

5. The method according to claim 4, further comprising:
receiving, as the transmission conditions, an attribute of the metadata and an attribute value of the attribute; and
transmitting, when the printing of the print setting referring to the received attribute value is executed in the job ticket, the printing status.

6. The method according to claim 4, further comprising:
receiving, as the transmission condition, a content of a message transmitted to the transmission destination; and
transmitting, when if the printing of the print setting referring to the metadata associated with the transmission condition is executed in the job ticket, the printing status based on the content of the message designated by the transmission condition.

7. A storage medium for storing a program to be executed by a computer, the program causing the computer to execute:
setting metadata for an arbitrary content among a plurality of contents included in a print job;
generating a job ticket in which the set metadata is associated with a print setting set for the print job;
receiving a transmission condition of a printing status in association with the set metadata;
executing printing according to the print setting of the generated job ticket; and
transmitting, when the printing of the print setting referring to the metadata associated with the transmission condition is executed in the job ticket, the printing status to a transmission destination designated by the transmission condition.
